(19) United States
(12) Patent Application Publication
(10) Pub. No.: US 2010/0039509 A1
(43) Pub. Date: Feb. 18, 2010

(54) System and Method for Determining the Kosher Status of Fish

(75) Inventor: Barnet Libeman, New York, NY (US)

Correspondence Address: COHEN, PONTANI, LIEBERMAN & PAVANE LLP, 551 FIFTH AVENUE, SUITE 1210, NEW YORK, NY, 10176, US

(73) Assignee: Winterlab Limited, New York, NY (US)

(21) Appl. No.: 12/594,299

(22) PCT Filed: Apr. 14, 2008
(86) PCT No.: PCT/US08/04836

§ 371 Date: Oct. 1, 2009

Related U.S. Application Data
(60) Provisional application No. 60/923,379, filed on Apr. 13, 2007.

(51) Int. Cl. H04N 7/18

(52) U.S. Cl. 348/89; 348/E07.085

(57) ABSTRACT

Presented are a system and a method for determining the kosher status of fish. The system includes a fish processing apparatus configured to process the fish, and at least one image recording apparatus configured to record images of the fish during processing. The images include information regarding whether or not the fish have scales. The system also includes at least one image display apparatus that is configured to view the at least one image of the at least one fish and enable an authorized inspecting party to compare the at least one image of the at least one fish with the at least one fish.

### CROSS REFERENCE TO RELATED CASES

This application claims priority to, and the benefit of, provisional U.S. Patent Application Ser. No. 60/923,379, filed Apr. 13, 2007, the entirety of which is incorporated herein by reference.

### TECHNICAL FIELD

The invention relates generally to fish, and more particularly to a system and method for determining the kosher status of fish.

### BACKGROUND OF THE INVENTION

For fish to be considered kosher, the fish must have scales. There are several existing methods of verifying that a particular fish is kosher. One such method requires that each fish be visually inspected for the presence of scales before it is skinned. This method is clearly inefficient. When each fish cannot be visually inspected for the presence of scales before it is skinned, a strip of skin that includes the scales from the fish is left attached to the otherwise skinned fish so that the scales are visible through the packaging to a purchaser. Yet, another approach involves packaging a strip of skin from the fish that includes scales along with the skinned fish, again, so that a purchaser can see the scales through the packaging.

### SUMMARY

In one aspect, the invention involves a system for determining the kosher status of at least one fish. The system includes a fish processing apparatus configured to process the least one fish, and at least one image recording apparatus configured to record at least one image of the at least one fish during processing. The at least one image includes information regarding whether or not the at least one fish has scales. The system further includes at least one image display apparatus configured to view the at least one image of the at least one fish and enable an authorized inspecting party to compare the at least one image of the at least one fish with the at least one fish.

In some embodiments, the fish processing apparatus includes a fish scaling station, a fish filleting station, a fish weighing station, a fish sampling station, and/or a fish profile scanning station.

In another embodiment, the at least one image recording apparatus includes a camera.

In still other embodiments, the system includes a data storage device configured to store the at least one image and a local monitoring system in communication with the at least one image recording apparatus and the data storage device. The local monitoring system includes a computer system comprising a display, a processor, and a data entry device.

In another embodiment, the system further includes a remote monitoring system in communication with the data storage device.

In yet another embodiment, the at least one image further includes a time and date stamp.

In still another embodiment, the information regarding whether or not the at least one fish has scales includes an image of the at least one fish before the at least one fish is completely skinned thereby indicating whether or not the at least one fish has scales.

In another aspect, the invention involves a method of determining the kosher status of at least one fish. The method includes tagging the at least one fish as the at least one fish is processed, capturing at least one image of the tagged at least one fish as the at least one fish is processed, storing the at least one image of the at least one fish, and comparing the stored image of the at least one fish to the tagged at least one fish.

In one embodiment, the method further includes scanning the at least one fish and comparing the scan of the at least one fish to stored profiles of kosher fish.

### BRIEF DESCRIPTION OF THE DRAWINGS

In the drawings, like reference characters refer to the same parts throughout the different views. Also, the drawings are not necessarily to scale, emphasis instead generally being placed upon illustrating the principles of the invention.

FIG. 1 is an illustrative block diagram of a system for determining the kosher status of fish, according to one embodiment of the invention.

FIG. 2 is an illustrative flow diagram of a method for determining the kosher status of fish, according to one embodiment of the invention.

### DETAILED DESCRIPTION

Typically, during the processing of fish at a fish processing plant, an authorized inspector is present in the processing area of the plant. In particular, when processing kosher fish, a rabbi is typically present to confirm the kosher status of the processed fish. However, when an on-site authorized inspector, such as a rabbi, is not possible, remote inspection or after-processing inspection is necessary. The present invention involves a system and method for remotely inspecting and determining the kosher status of fish, either individually or by lot, during processing in a fish processing plant or determining the kosher status of fish after the fish has been processed.

Typically in fish processing, fish are gilled and gutted either on a fishing boat, or at the processing facility. Thereafter, the fish are put into the production line for processing, which includes skinning, filleting, cleaning, weighing.

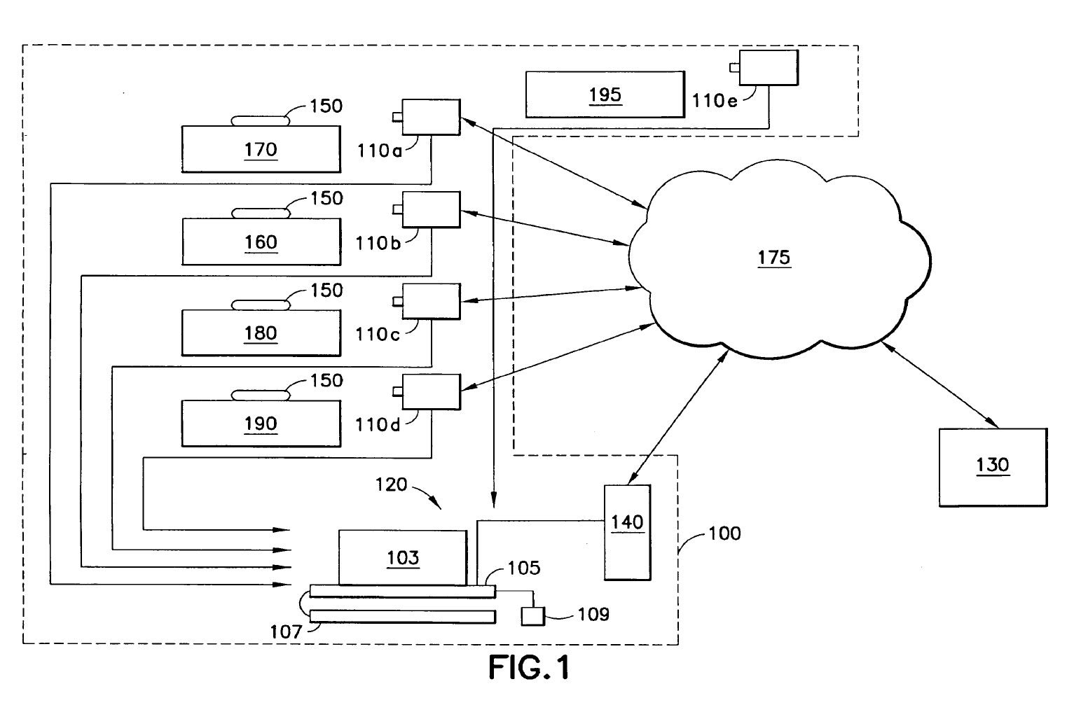

Referring to FIG. 1, in one embodiment, a system for identifying and recording the kosher status of fish is shown. The system is intended to be installed in a typical fish processing facility and incorporated in the production line. The system includes one or more cameras 110a, 110b, 110c, 110d, a first remote monitoring system 120, a second remote monitoring system 130, and a data storage device 140.

The cameras 110a and 110b are located near a fish skinning area in a fish packaging plant 100. For example, the camera 110a provides a close view of each fish 150 as it is skinned at a hand skinning station 170, and the camera 110b provides a close view of each fish 150 as it is skinned by automated fish skinning equipment 160. The cameras 110a, 110b are in wired or wireless communication with the first remote monitoring system 120, which is also located in the fish processing plant 100.

After each fish 150 is skinned, each fish 150 is tagged. The tag is affixed to the fish 150 in such a way so as to be easily seen by the camera 110a or 110b. In some embodiments, the tag includes a unique alphanumeric identifier and a time/date stamp. The tag is used to later find the images of the fillet 150 captured during the skinning process. For example, in one embodiment, the time/date stamp on the tag is used to find the images of the fillet that were taken at the same time and on the same date. In another embodiment, the images of a particular fish are stored with filenames or in a directory on the storage device 140 with a title that include the unique identifier on the tag of the particular fish.

In another embodiment, in addition to, or in place of the “tagging” of individual fish, standard production run coding can be used and the fish are identified as belonging to a lot that is determined by the time period of processing. The size of lot is determined by the manufacturer. If one fish in a particular lot does not meet a particular standard, the entire lot is declared “out of specification” or “not kosher”.

In other embodiments, in addition to the skinning area, a camera 110c is located at a filleting and cleaning station 180 and a camera 110d is located at a weight sort station 190.

At the filleting and cleaning station 180, the fish are filleted and cleaned. At the weight sort station 190, the now filleted fish 150 are weighed and compared to an established weight profile for the species of fish that is being processed. If the particular fish fillet 150 does not meet an established weight profile for the species of fish being processed, the fish fillet 150 is sorted into another bin, which contains fish independent of weight, for further inspection to confirm the species of the fish. The cameras 110c, 110d are also in communication with remote monitoring system 120.

The cameras 110a, 110b, 110c, 110d have an image resolution that allows scales on the fish skin to be easily detected and for the associated tag to be easily read. The cameras 110a, 110b, 110c, 110d each include a time and date stamping mechanism that is used to time and date the images of each fish as it is skinned, filleted and cleaned, and weighed.

Further, the cameras 110a, 110b, 110c, 110d each include a networking capability (either wired or wireless) to transmit pictures of the fillets over a network 175, such as a local area network, wide area network, the Internet, or the World Wide Web, for example. The cameras 110a, 110b, 110c, 110d are also in communication (wired or wireless) with a data storage device 140, such as a computer hard disk, to store images of the fish. The data storage device is accessible by any authorized inspecting party.

In one embodiment, the first remote monitoring system 120 includes a display 103, a central processing unit (CPU) 105, and data entry devices, such as a keyboard 107, and/or a mouse 109. The first remote monitoring system 120 is also in communication with the data storage device 140. An inspecting party uses the remote monitoring system to view live images from the camera 110a, 110b, 110c, and 110d as the fish is being skinned, filleted, and weighed. Further, the inspecting party can use the first remote monitoring system 120 to access the data storage device 140 to view stored images of fish previously skinned, filleted, and weighed. The time/date stamps on the stored images enable an inspecting party to locate specific images of a tagged fillet or lot of fillets to identify the kosher status of the tagged fillet or lot in the fish processing plant 100.

Additionally, an inspecting party in a remote location can access the data storage device 140 via the network 175 and view the stored images via the second remote monitoring system 130. The time/date stamps on the stored images enable an inspecting party to locate specific images of a finished/packaged fillet, which also includes the unique identifier and/or time/date stamp, to identify the kosher status and/or species of the finished/packaged fish.

In another embodiment, the system includes a fish sampling station 195. At the fish sampling station, a sample of a tagged fish or fillet is obtained and can be later used for microscopic analysis, DNA analysis, antibody tests, or other chemical analysis developed for determining the species of fish. The results of the tests can be stored on the data storage device 140 and accessed directly or remotely by an authorized inspecting party. The fish sampling station 195 can also be viewed using camera 110e.

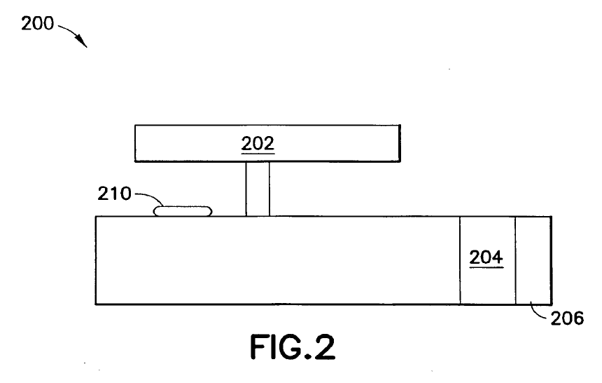

Referring to FIG. 2, in another embodiment, the system includes a fish profile scanning station 200. The fish profile scanning station includes a scanner 202, a processing apparatus such as a computer 204, and a fish profile database 206.

After a fish is gutted and before it is skinned, the fish profile scanning station scans each fish 210 before the fish 210 skinned and filleted to identify the fish species. The scanning station 200 scans each fish 210 and compares the data obtained from the scan to pre-stored profiles for standard types of fish that are stored in the fish profile database 206.

The pre-stored fish profiles include expected shape (contours), weight, density, and/or size for each species of fish. If the scanned fish 210 does not match the expected fish profile, the particular fish 210 is rejected. If the scanned fish 210 matches the profile, the particular fish 210 is passed to the automated fish skinning equipment 160 or sent to the hand skinning station 170.

Variations, modifications, and other implementations of what is described herein may occur to those of ordinary skill in the art without departing from the spirit and scope of the disclosed subject matter. Further, the various features of the embodiments described herein also can be combined, rearranged, or separated without departing from the spirit and scope of the disclosed subject matter. Accordingly, the invention is not to be defined only by the preceding illustrative description.

What is claimed is:

1. A system for determining the kosher status of the at least one fish, comprising:
a fish processing apparatus configured to process the least one fish;
at least one image recording apparatus configured to record at least one image of the at least one fish during processing, the at least one image comprising information regarding whether or not the at least one fish has scales; and
at least one image display apparatus configured to view the at least one image of the at least one fish and enable an authorized inspecting party to compare the at least one image of the at least one fish with the at least one fish.

2. The system of claim 1, wherein the fish processing apparatus comprises a fish scaling station.

3. The system of claim 1, wherein the fish processing apparatus comprises a fish filleting station.

4. The system of claim 1, wherein the fish processing apparatus comprises a fish weighing station.

5. The system of claim 1, wherein the fish processing apparatus comprises a fish sampling station.

6. The system of claim 1, wherein the fish processing apparatus comprises a fish profile scanning station.

7. The system of claim 1, wherein the at least one image recording apparatus comprises a camera.

8. The system of claim 1, further comprising a data storage device configured to store the at least one image.

9. The system of claim 1, further comprising a local monitoring system in communication with the at least one image recording apparatus and the data storage device.

10. The system of claim 9, wherein the local monitoring system comprises a computer system comprising a display, a processor, and a data entry device.

11. The system of claim 1, further comprising a remote monitoring system in communication with the data storage device.

12. The system of claim 1, wherein the at least one image further comprises a time and date stamp.

13. The system of claim 1, wherein the information regarding whether or not the at least one fish has scales comprises an image of the at least one fish before the at least one fish is completely skinned thereby indicating whether or not the at least one fish has scales.

14. A method of determining the kosher status of at least one fish, comprising:
tagging the at least one fish as the at least one fish is processed;
capturing at least one image of the tagged at least one fish as the at least one fish is processed;
storing the at least one image of the at least one fish; and
comparing the stored image of the at least one fish to the tagged at least one fish.

15. The method of claim 14, further comprising scanning the at least one fish and comparing the scan of the at least one fish to stored profiles of kosher fish.
